(19) United States
(12) Patent Application Publication
(10) Pub. No.: US 2021/0089159 A1
(43) Pub. Date: Mar. 25, 2021

(54) WRITING FEEL IMPROVING SHEET

(71) Applicant: LINTEC CORPORATION, Tokyo (JP)

(72) Inventors: Hiroki HOSHINO, Tokyo (JP); Yuka FUJII, Tokyo (JP)

(73) Assignee: LINTEC CORPORATION, Tokyo (JP)

(21) Appl. No.: 17/029,597

(22) Filed: Sep. 23, 2020

(30) Foreign Application Priority Data
Sep. 24, 2019 (JP) 2019-173142

(51) Int. Cl. G06F 3/041; G06F 3/0354

(52) U.S. Cl. CPC G06F 3/0414; G06F 3/03545

(57) ABSTRACT

A writing feel improving sheet having a touch pen contact surface with which a touch pen comes into contact, the touch pen contact surface having an indentation depth of 10 μm or more and 30 μm or less when a test load reaches 1961 mN upon indentation with a tip of a triangular pyramid-shaped indenter at a load speed of 1 mN/s, the triangular pyramid-shaped indenter having a tip curvature radius of 100 nm and an inter-ridge angle of 115°.

### TECHNICAL FIELD

The present invention relates to a writing feel improving sheet that can improve the writing feel with a touch pen on a touch panel or the like.

### BACKGROUND ART

In recent years, image display devices (touch panels) having a position detection function and serving both as a display device and as an input means are widely used in various electronic devices. Such touch panels include those in which the input operation is performed by a finger as well as those in which the input operation is performed using a touch pen. The touch pen allows the input operation to be performed with a higher degree of accuracy than by a finger. Usually, however, display modules of touch panels are rigid. The writing feel with a touch pen is therefore different from the writing feel when writing on paper with a pen or pencil and cannot be said to be good.

To solve the problem of writing feel with a touch pen on a touch panel, controlling physical properties of the surface of a touch panel is studied. For example, Patent Document 1 discloses a resistive film-type touch panel having an input operation surface whose pencil hardness, surface energy, and elastic deformability are adjusted within predetermined ranges. Patent Document 2 discloses that a sheet is provided on the outermost surface of a touch panel to improve the writing feel (such a sheet may be referred to as a “writing feel improving sheet,” hereinafter). This sheet is a transparent laminate in which a surface treatment layer, a transparent rigid layer, and a transparent relaxation layer having a thickness of 0.2 to 2 mm are laminated in this order.

### PRIOR ART DOCUMENTS

### Patent Documents

[Patent Document 1] JP2001-243016A

[Patent Document 2] JP2004-259256A

### SUMMARY OF THE INVENTION

### Problems to be Solved by the Invention

According to the inventions disclosed in Patent Document 1 and Patent Document 2, however, the writing feel when writing on paper with a pen or pencil (in particular, a ballpoint pen) was not sufficiently obtained. Thus, there is a demand for the development of a writing feel improving sheet that further well reproduces the writing feel when writing on paper with a pen or pencil.

The present invention has been made in consideration of such actual circumstances and an object of the present invention is to provide a writing feel improving sheet that can well reproduce the writing feel when writing on paper with a pen or pencil.

### Means for Solving the Problems

To achieve the above object, first, the present invention provides a writing feel improving sheet having a touch pen contact surface with which a touch pen comes into contact, the touch pen contact surface having an indentation depth of 10 μm or more and 30 μm or less when a test load reaches 1961 mN upon indentation with a tip of a triangular pyramid-shaped indenter at a load speed of 1 mN/s, the triangular pyramid-shaped indenter having a tip curvature radius of 100 nm and an inter-ridge angle of 115° (Invention 1).

The writing feel improving sheet according to the above invention (Invention 1) satisfies the above-described indentation depth and can thereby well reproduce the feeling of depression on paper when writing on the paper with a pen or pencil (in particular, a ballpoint pen). This allows the writing feel when writing on paper with a pen or pencil to be reproduce well.

In the above invention (Invention 1), the writing feel improving sheet may preferably have a dynamic friction coefficient of 0.11 or more and 0.62 or less when, after a pen tip of a touch pen is brought into contact with the touch pen contact surface, a load of 200 g is applied to the touch pen and the touch pen is linearly slid at a speed of 1.6 mm/s while maintaining an angle formed between the touch pen and the touch pen contact surface at 45°, the pen tip having a diameter of 0.5 mm (Invention 2).

In the above invention (Invention 1, 2), the writing feel improving sheet may preferably comprise: a writing feel improving layer; a base material provided on one surface side of the writing feel improving layer; and a pressure sensitive adhesive layer provided on a surface side of the base material opposite to the writing feel improving layer, wherein the touch pen contact surface may be a surface of the writing feel improving layer opposite to the base material (Invention 3).

In the above invention (Invention 3), the writing feel improving layer may preferably be laminated directly on one surface of the base material (Invention 4).

In the above invention (Invention 3, 4), the writing feel improving layer may preferably be a hard coat layer (Invention 5).

### Advantageous Effect of the Invention

The writing feel improving sheet according to the present invention can well reproduce the writing feel when writing on paper with a pen or pencil.

### EMBODIMENTS FOR CARRYING OUT THE INVENTION

Hereinafter, one or more embodiments of the present invention will be described.

The writing feel improving sheet according to an embodiment of the present invention has a touch pen contact surface with which a touch pen comes into contact. Both surfaces of the writing feel improving sheet according to the present embodiment may be the touch pen contact surfaces, but usually one surface of the writing feel improving sheet may be the touch pen contact surface and the other surface may be a surface for being attached to a touch panel or the like.

### 1. Physical Properties of Writing Feel Improving Sheet

### (1) Depression Depth

In the writing feel improving sheet according to the present embodiment, the indentation depth of the touch pen contact surface is 10 μm or more and 30 μm or less when a test load reaches 1961 mN upon indentation with a tip of a triangular pyramid-shaped indenter at a load speed of 1 mN/s. The triangular pyramid-shaped indenter has a tip curvature radius of 100 nm and an inter-ridge angle of 115°. When the indentation depth is within the above range, the feeling of depression when writing on the touch pen contact surface with a touch pen is very close to the feeling of depression when writing on paper with a pen or pencil, and excellent writing feel can be achieved.

From the viewpoint of more improving the reproducibility of the depression feel as described above, the above-described indentation depth may be preferably 12 μm or more and particularly preferably 16.5 μm or more. From the same viewpoint, the above-described indentation depth may be preferably 25 μm or less and particularly preferably 20 μm or less. Details of the method of measuring the above-described indentation depth are as described in the testing example, which will be described later.

### (2) Friction Coefficients

In the writing feel improving sheet according to the present embodiment, when, after the pen tip of a touch pen is brought into contact with the touch pen contact surface, a load of 200 g is applied to the touch pen and the touch pen is linearly slid at a speed of 1.6 mm/s while maintaining an angle formed between the touch pen and the touch pen contact surface at 45°, the dynamic friction coefficient may be preferably 0.11 or more, particularly preferably 0.18 or more, and further preferably 0.23 or more. The pen tip has a diameter of 0.5 mm. From another aspect, the above-described dynamic friction coefficient may be preferably 0.62 or less, more preferably 0.52 or less, particularly preferably 0.42 or less, and further preferably 0.32 or less.

When the dynamic friction coefficient is within the above-described range, upon the use of a touch pen on a touch panel to which the writing feel improving sheet is attached, the feeling of vibration transmitted to the hand holding the touch pen is very close to the feeling of vibration obtained upon the writing on paper with a pen or pencil (in particular, a ballpoint pen). This allows more excellent writing feel to be readily achieved together with the above-described feeling of depression.

In the writing feel improving sheet according to the present embodiment, when, after the pen tip of a touch pen is brought into contact with the touch pen contact surface, a load of 200 g is applied to the touch pen and the touch pen is linearly slid at a speed of 1.6 mm/s while maintaining an angle formed between the touch pen and the touch pen contact surface at 45°, the static friction coefficient may be preferably 0.12 or more, particularly preferably 0.20 or more, and further preferably 0.25 or more. The pen tip has a diameter of 0.5 mm. From another aspect, the above-described static friction coefficient may be preferably 0.65 or less, more preferably 0.55 or less, particularly preferably 0.45 or less, and further preferably 0.35 or less.

When the static friction coefficient is within the above-described range, upon the use of a touch pen on a touch panel to which the writing feel improving sheet is attached, the feeling of vibration at the start of writing is very close to the feeling of vibration obtained upon the writing on paper with a pen or pencil (in particular, a ballpoint pen). This allows more excellent writing feel to be readily achieved together with the above-described feeling of depression.

### (3) Standard Deviation of Friction Force

In the writing feel improving sheet according to the present embodiment, when, after the pen tip of a touch pen is brought into contact with the touch pen contact surface, a load of 200 g is applied to the touch pen and the touch pen is linearly slid at a speed of 1.6 mm/s while maintaining an angle formed between the touch pen and the above surface at 45°, the standard deviation of the friction force generated between the pen tip and the above surface may be preferably 5 mN or more, more preferably 8 mN or more, and particularly preferably 11 mN or more. The pen tip has a diameter of 0.5 mm. The friction force is measured between a point at which the sliding distance is 10 mm and a point at which the sliding distance is 20 mm. From another aspect, the standard deviation may be preferably 60 mN or less, more preferably 40 mN or less, and particularly preferably 30 mN or less. When the standard deviation is within the above range, the feeling of vibration upon the use of a touch pen on a touch panel to which the writing feel improving sheet is attached is very close to the feeling of vibration upon the writing on paper with a pen or pencil (in particular, a ballpoint pen).

Details of the methods of measuring the above-described dynamic friction coefficient, static friction coefficient, and standard deviation of friction force are as described in the testing examples, which will be described later.

### (4) Optical Properties

The haze value of the writing feel improving sheet according to the present embodiment is not particularly limited and may be preferably 0.5% or more and more preferably 1% or more. From the viewpoint of obtaining sufficient antiglare properties, the haze value may be particularly preferably 15% or more and further preferably 22% or more. On the other hand, the above haze value may be preferably 95% or less, particularly preferably 65% or less, and further preferably 40% or less. When the above haze value is 95% or less, the writing feel improving sheet according to the present embodiment has higher transparency. The above haze value is measured in accordance with JIS K7136:2000, and the detailed measuring method is as described in the testing example, which will be described later.

The total luminous transmittance of the writing feel improving sheet according to the present embodiment may be preferably 70% or more, particularly preferably 80% or more, and further preferably 88% or more. When the above total luminous transmittance is 70% or more, the writing feel improving sheet according to the present embodiment has higher transparency. On the other hand, the upper limit of the total luminous transmittance is not particularly limited and may be, for example, preferably 100% or less, particularly preferably 96% or less, and further preferably 92% or less. The above total luminous transmittance is measured in accordance with JIS K7361-1:1997, and the detailed measuring method is as described in the testing example, which will be described later.

In the writing feel improving sheet according to the present embodiment, the glossiness at a measurement angle of 60° on the touch pen contact surface may be preferably 1% or more, particularly preferably 10% or more, and further preferably 20% or more. From another aspect, the above glossiness may be preferably 130% or less, particularly preferably 90% or less, and further preferably 60% or less. When the glossiness is within the above range, the antiglare properties suitable for the use of a touch panel for which the writing feel improving sheet is used can readily be achieved. The above glossiness is measured in accordance with JIS Z 8741:1997, and the detailed measuring method is as described in the testing example, which will be described later.

### (5) Scratch Resistance

In the writing feel improving sheet according to the present embodiment, when the touch pen contact surface is rubbed at a load of 250 g/cm² using #0000 steel wool to reciprocate it ten times within a length of 10 cm, the number of scratches generated may be preferably 10 or less, particularly preferably 5 or less, and further preferably 0. This allows the touch pen contact surface of the writing feel improving sheet according to the present embodiment to exhibit good hard coat properties and excellent scratch resistance. The scratch resistance based on the evaluation of the hardness with the steel wool may readily be achieved when the writing feel improving sheet according to the present embodiment includes a hard coat layer as a writing feel improving layer as described later. The detailed method of measuring the above scratch resistance is as described in the testing example, which will be described later.

### (6) Pencil Hardness

In the writing feel improving sheet according to the present embodiment, the scratch hardness (pencil hardness) of the touch pen contact surface may be preferably 3B or more and particularly preferably HB or more. The scratch hardness is measured by a pencil method in accordance with JIS K5600-5-4:1999. When the touch pen contact surface of the writing feel improving sheet according to the present embodiment has such pencil hardness, desired hardness/scratch resistance can readily be exhibited. The detailed method of measuring the pencil hardness is as described in the testing example, which will be described later.

### 2. Layer Structure of Writing Feel Improving Sheet

The layer structure of the writing feel improving sheet according to the present embodiment is not particularly limited, provided that it satisfies the previously described indentation depth for the touch pen contact surface and is applicable to a touch panel on which a touch pen is used.

From the viewpoint of readily achieving the previously described indentation depth and easily adjusting other physical properties, the writing feel improving sheet according to the present embodiment may preferably include a writing feel improving layer, a base material provided on one surface side of the writing feel improving layer, and a pressure sensitive adhesive layer provided on the surface side of the base material opposite to the writing feel improving layer. When this layer structure is employed, the touch pen contact surface may preferably be the surface of the writing feel improving layer opposite to the base material.

### (1) Base Material

The above base material can be appropriately selected from those suitable for a touch panel on which a touch pen is used. For example, a plastic film, a glass plate, or the like can be used as the above base material, but it may be preferred to use a plastic film from the viewpoint of good affinity with the writing feel improving layer.

Examples of such a plastic film include films of polyesters such as polyethylene terephthalate, polybutylene terephthalate and polyethylene naphthalate, polyolefin films such as a polyethylene film and a polypropylene film, cellophane, a diacetyl cellulose film, a triacetyl cellulose film, an acetyl cellulose butyrate film, a polyvinyl chloride film, a polyvinylidene chloride film, a polyvinyl alcohol film, an ethylene-vinyl acetate copolymer film, a polystyrene film, a polycarbonate film, a polymethylpentene film, a polysulfone film, a polyether ether ketone film, a polyether sulfone film, a polyether imide film, a fluorine resin film, a polyamide film, an acrylic resin film, a polyurethane resin film, a norbornene-based polymer film, a cyclic olefin-based polymer film, a cyclic conjugated diene-based polymer film, a vinyl alicyclic hydrocarbon polymer film, other appropriate plastic films, and laminated films thereof. Among these, the polyester film may be preferably used and the polyethylene terephthalate may be particularly preferably used from the viewpoint of readily achieving the previously described indentation depth.

For the purpose of improving the interfacial adhesion between the above base material and a layer provided on the base material (such as the writing feel improving layer, the pressure sensitive adhesive layer, or an intermediate layer to be described later), if desired, one surface or both surfaces of the base material may be provided with an easy-adhesion layer formed by primer treatment or the like and/or a surface treatment layer formed by an oxidation method, a roughening method, or the like. Examples of the above oxidation method include corona discharge treatment, chromic acid treatment, flame treatment, hot-air treatment, and ozone/ultraviolet treatment. Examples of the above roughening method include a sandblast method and a solvent treatment method.

In the present specification, the above-described easy-adhesion layer and surface treatment layer are defined as being a part that constitutes the base material. Accordingly, even when a writing feel improving sheet is assumed in which the writing feel improving layer is laminated directly on the base material, for example, the possibility that the above-described easy-adhesion layer and/or surface treatment layer are present on the base material of such a writing feel improving sheet is not excluded.

The thickness of the base material may be preferably 5 μm or more, particularly preferably 10 μm or more, and further preferably 15 μm or more. When the lower limit of the thickness of the base material is within the above range, the writing feel improving sheet according to the present embodiment may readily have sufficient strength. From another aspect, the thickness of the base material may be preferably 300 μm or less, more preferably 200 μm or less, particularly preferably 150 μm or less, and further preferably 100 μm or less. When the upper limit of the thickness of the base material is within the above range, the writing feel improving sheet according to the present embodiment may readily achieve the previously described indentation depth.

### (2) Writing Feel Improving Layer

The material for forming the above writing feel improving layer is not particularly limited, provided that it can achieve the previously described indentation depth. The writing feel improving layer may be a hard coat layer having hard coat properties. In this case, the touch pen contact surface may readily have good scratch resistance.

The writing feel improving layer may be preferably formed by curing a coating composition, which will be described below. In particular, the coating composition may preferably contain a curable component, fine particles, a surface conditioner, and silica nanoparticles. Using such a coating composition, it becomes easy to form a hard coat layer that well has the above-described hard coat properties.

### (2-1) Curable Component

The curable component may be a component that is cured by a trigger such as active energy rays or heat, and examples of the curable component include an active energy ray-curable component and a thermosetting component. In the present embodiment, it may be preferred to use the active energy ray-curable component from the viewpoint of the hardness of the writing feel improving layer formed, the heat resistance of the base material (plastic film), and the like.

The active energy ray-curable component may preferably be a component that can be cured by irradiation with active energy rays to exhibit predetermined hardness and achieve the previously described physical properties.

Specific examples of the active energy ray-curable component include polyfunctional (meth)acrylate-based monomer, (meth)acrylate-based prepolymer, and active energy ray-curable polymer, among which the polyfunctional (meth)acrylate-based monomer and/or (meth)acrylate-based prepolymer may be preferred. The polyfunctional (meth)acrylate-based monomer and the (meth)acrylate-based prepolymer may each be used alone or both may also be used in combination. As used in the present specification, the (meth)acrylate refers to both an acrylate and a methacrylate. The same applies to other similar terms.

Examples of the polyfunctional (meth)acrylate-based monomer include 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylol propane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl)isocyanurate, pentaerythritol tetra(meth)acrylate, propionic acid-modified dipentaerythritol penta(meth)acrylate, dipentaerythritol hexa(meth)acrylate, ethylene oxide-modified dipentaerythritol hexa(meth)acrylate, caprolactone-modified dipentaerythritol hexa(meth)acrylate, and other appropriate polyfunctional (meth)acrylates. These may each be used alone or two or more types may also be used in combination.

On the other hand, examples of the (meth)acrylate-based prepolymer include urethane acrylate-based, polyester acrylate-based, epoxy acrylate-based, and polyol acrylate-based prepolymers. Among these, the urethane acrylate-based prepolymer may preferably be used from the viewpoint of readily achieving the previously described indentation depth.

Examples of the urethane acrylate-based prepolymer include a reaction product generated by esterifying, with (meth)acrylic acid, a hydroxyl group of a polyurethane preoligomer that is obtained from polyether polyol or polyester polyol and polyisocyanate; and a reaction product generated by reacting a hydroxyl group-containing (meth)acrylic acid with a terminal isocyanate polyurethane oligomer that is obtained by the reaction between polyether polyol or polyester polyol and polyisocyanate.

### (2-2) Fine Particles

When the coating composition contains fine particles, the surface of the writing feel improving layer formed can be a moderately rough surface; therefore, the haze value and 60° glossiness may easily be adjusted to the previously described values, and the previously described friction coefficients and standard deviation of friction force may also be readily achieved.

The above fine particles refer to those having a larger average particle diameter than that of silica nanoparticles, which will be described later. For example, the average particle diameter of the above fine particles may be preferably 1 μm or more, particularly preferably 2 μm or more, and further preferably 3 μm or more. From another aspect, the average particle diameter of the above fine particles may be preferably 20 μm or less, more preferably 16 μm or less, particularly preferably 12 μm or less, and further preferably 6 μm or less. When the average particle diameter of the above fine particles is within the above range, the previously described haze value, 60° glossiness, friction coefficients, and standard deviation of friction force may readily be achieved.

The coefficient of variation (CV value) of the particle diameter of the above fine particles represented by the following equation may be preferably 3% or more, particularly preferably 8% or more, and further preferably 13% or more. On the other hand, the coefficient of variation (CV value) of the particle diameter may be preferably 70% or less, particularly preferably 45% or less, and further preferably 25% or less. When the CV value of the above fine particles is within the above range, the roughened shape of the surface may easily be adjusted, and the previously described standard deviation of friction force may readily be achieved.

Coefficient of variation (CV value) of particle diameter=(Standard deviation particle diameter/Average particle diameter)×100

The above-described average particle diameter and coefficient of variation (CV value) of the fine particles refer to values measured with a laser diffraction and scattering-type particle diameter distribution measurement device using a few drops of a dispersion liquid as a sample. The dispersion liquid is prepared with methyl ethyl ketone as a dispersion medium and has a concentration of 5 mass %.

The above fine particles may be organic fine particles, inorganic fine particles, or resin fine particles having both inorganic and organic properties. From the viewpoint of readily achieving the previously described standard deviation of friction force, the fine particles may preferably be organic fine particles or resin fine particles having both inorganic and organic properties.

Examples of the organic fine particles include acrylic-based resin fine particles (such as polymethylmethacrylate fine particles), silicone-based fine particles, melamine-based resin fine particles, acrylic-styrene-based copolymer fine particles, polycarbonate-based fine particles, polyethylene-based fine particles, polystyrene-based fine particles, and benzoguanamine-based resin fine particles. These resins may be crosslinked. Among the above, the acrylic-based resin fine particles and the silicone-based fine particles may be preferred from the viewpoint of readily achieving the previously described standard deviation of friction force. In particular, as the acrylic-based resin fine particles, polymethylmethacrylate fine particles may be preferred and crosslinked polymethylmethacrylate fine particles may be further preferred.

Examples of the inorganic fine particles include fine particles composed of silica, alumina, titania, zirconia, tin oxide, indium oxide, cadmium oxide, antimony oxide, and the like.

Particularly preferred resin fine particles having both the inorganic and organic properties may be silicone fine particles (e.g., Tospearl series available from Momentive Performance Materials Japan).

One type of the above fine particles may be used alone or two or more types may also be used in combination.

The above fine particles may be subjected to a desired surface modification. The shape of the fine particles may be a finite shape such as a spherical shape or may also be an indefinite shape in which the shape is not specified. From the viewpoint of readily achieving the previously described standard deviation of friction force, the shape of the fine particles may be preferably a definite shape and particularly preferably a spherical shape.

The content of the fine particles in the coating composition may be preferably 0.01 mass parts or more, more preferably 0.1 mass parts or more, particularly preferably 1 mass part or more, and further preferably 7 mass parts or more with respect to 100 mass parts of the curable component. From another aspect, the content of the fine particles in the coating composition may be preferably 50 mass parts or less, particularly preferably 30 mass parts or less, and further preferably 15 mass parts or less with respect to 100 mass parts of the curable component. When the content of the fine particles is within the above range, the previously described friction coefficients and standard deviation of friction force may readily be achieved.

### (2-3) Surface Conditioner

When the coating composition contains a surface conditioner, generation of streaky defects, unevenness, and the like can be suppressed in the writing feel improving layer formed. This allows the film thickness to be uniform, and the writing feel improving sheet can have a more excellent appearance and can readily have desired optical properties (such as the haze value and the total luminous transmittance). Moreover, the surface of the writing feel improving layer of the writing feel improving sheet may readily be in a good surface state and, therefore, the writing feel improving layer can readily achieve the previously described friction coefficients and standard deviation of friction force.

Examples of the surface conditioner include fluorine-based, silicone-based, acrylic-based, and vinyl-based surface conditioners. Among these, the fluorine-based surface conditioner may be preferred from the viewpoint of the surface conditioning performance and the compatibility with other components. One type of the surface conditioner may be used alone or two or more types may also be used in combination.

Preferred examples of the fluorine-based surface conditioner include a compound having a perfluoroalkyl group or a fluorinated alkenyl group in the main chain or a side chain. Examples of commercially available products include, but are not limited to, BYK-340 available from BYK Japan KK., Ftergent 650A available from NEOS COMPANY LIMITED, Megafac RS-75 available from DIC, and V-8FM available from OSAKA ORGANIC CHEMICAL INDUSTRY LTD. The silicone-based surface conditioner may be preferably polydimethylsiloxane or modified polydimethylsiloxane and particularly preferably polydimethylsiloxane.

The content of the surface conditioner in the coating composition may be preferably 0.01 mass parts or more, particularly preferably 0.1 mass parts or more, and further preferably 0.2 mass parts or more with respect to 100 mass parts of the curable component. From another aspect, the content of the surface conditioner in the coating composition may be preferably 10 mass parts or less, more preferably 5 mass parts or less, particularly preferably 3 mass parts or less, and further preferably 1 mass part or less with respect to 100 mass parts of the curable component. When the content of the surface conditioner is within the above range, the appearance of the writing feel improving sheet can be effectively improved. Moreover, the optical properties (such as the haze value and the total luminous transmittance) may easily be adjusted within the previously described range. Furthermore, the writing feel improving layer may readily achieve the previously described friction coefficients.

### (2-4) Silica Nanoparticles

When the coating composition contains silica nanoparticles, the hardness of the writing feel improving layer formed can be effectively improved.

The average particle diameter of the silica nanoparticles may be preferably 1 nm or more, particularly preferably 5 nm or more, and further preferably 10 nm or more. From another aspect, the average particle diameter of the silica nanoparticles may be preferably 300 nm or less, particularly preferably 100 nm or less, and further preferably 50 nm or less. The average particle diameter of the silica nanoparticles is measured with a laser diffraction and scattering-type particle diameter distribution measurement device.

The silica nanoparticles may be modified with an organic substance for the purpose of improving the dispersibility and the like. The silica nanoparticles may also be preferably in the form of an organosol (colloidal form). When the silica nanoparticles are in the form of an organosol, the dispersibility of the silica nanoparticles may be improved, and the homogeneity and light transmittance of the writing feel improving layer formed may be improved.

Commercially available products can be used as the above silica nanoparticles, and examples thereof include organosilica sol MEK-ST and MIBK-ST available from Nissan Chemical Corporation.

The content of the silica nanoparticles in the coating composition may be preferably 5 mass parts or more, particularly preferably 10 mass parts or more, and further preferably 15 mass parts or more with respect to 100 mass parts of the curable component. From another aspect, the content of the silica nanoparticles in the coating composition may be preferably 50 mass parts or less, particularly preferably 35 mass parts or less, and further preferably 25 mass parts or less with respect to 100 mass parts of the curable component. When the content of the silica nanoparticles is 5 mass parts or more, the hardness of the writing feel improving layer formed can be more effectively improved, and the occurrence of glare can be more effectively suppressed. On the other hand, when the compounding ratio of the silica nanoparticles is 50 mass parts or less, cohesion of the silica nanoparticles can be suppressed, and the homogeneity and light transmittance of the writing feel improving layer formed can be maintained well.

### (2-5) Other Components

The coating composition in the present embodiment may contain various additives in addition to the above components. Examples of such additives include a photopolymerization initiator, an ultraviolet absorber, an antioxidant, a light stabilizer, an antistatic, a silane coupling agent, an antiaging agent, a thermal polymerization inhibitor, a colorant, a surfactant, a storage stabilizer, a plasticizer, a glidant, an antifoam, an organic-based filler, a wettability improving agent, and a coating surface improving agent.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, and p-dimethylaminobenzoic ester. These may each be used alone or two or more types may also be used in combination.

The content of the photopolymerization initiator in the coating composition may be preferably 1 mass part or more and particularly preferably 2 mass parts or more with respect to 100 mass parts of the curable component. From another aspect, the content of the photopolymerization initiator in the coating composition may be preferably 10 mass parts or less and particularly preferably 5 mass parts or less with respect to 100 mass parts of the curable component.

### (2-6) Thickness

The thickness of the writing feel improving layer may be preferably 0.1 μm or more, particularly preferably 1 μm or more, and further preferably 2 μm or more. From another aspect, the thickness of the writing feel improving layer may be preferably 30 μm or less, more preferably 20 μm or less, particularly preferably 10 μm or less, and further preferably 4 μm or less. When the thickness of the writing feel improving layer is within the above range, the writing feel improving sheet according to the present embodiment may readily achieve the previously described indentation depth.

### (3) Pressure Sensitive Adhesive Layer

The pressure sensitive adhesive for forming the above pressure sensitive adhesive layer is not particularly limited, provided that it can achieve the previously described indentation depth. As the pressure sensitive adhesive, a product usually used for optical applications may be preferably used, and examples thereof include an acrylic-based pressure sensitive adhesive, a rubber-based pressure sensitive adhesive, a silicone-based pressure sensitive adhesive, a urethane-based pressure sensitive adhesive, a polyester-based pressure sensitive adhesive, and a polyvinyl ether-based pressure sensitive adhesive. Among these, the acrylic-based pressure sensitive adhesive may be preferred because it exhibits desired pressure sensitive adhesive properties and is excellent in the optical properties and durability.

Examples of the above-described acrylic pressure sensitive adhesive include a pressure sensitive adhesive obtained by crosslinking a pressure sensitive adhesive composition that contains a (meth)acrylic ester polymer and a crosslinker. In the present specification, the term “polymer” encompasses the concept of “copolymer.”

The (meth)acrylic ester polymer preferably contains, as a monomer unit constituting the polymer, a reactive group-containing monomer having a reactive group that reacts with a crosslinker in the molecule. The reactive group reacts with a crosslinker, which will be described later, thereby to allow the cohesive strength of the obtained pressure sensitive adhesive to be easily controlled within a desired range, and as a result, the previously described indentation depth can readily be achieved. The functional group-containing monomer may preferably be a monomer having a polymerizable double bond and a functional group such as a hydroxy group, a carboxy group, or an amino group in the molecule. It may be preferred to use, among such monomers, at least one of a monomer that contains a carboxy group as the functional group (carboxy group-containing monomer) and a monomer that contains a hydroxy group as the functional group (hydroxy group-containing monomer).

Examples of the above carboxy group-containing monomer include ethylenically unsaturated carboxylic acids such as acrylic acid and methacrylic acid, among which acrylic acid may be preferred. Preferred examples of the above hydroxy group-containing monomer include (meth)acrylic hydroxyalkyl esters such as (meth)acrylic 2-hydroxyethyl and (meth)acrylic 4-hydroxybutyl. These may each be used alone or two or more types may also be used in combination.

The (meth)acrylic ester polymer may preferably contain 1 mass % or more and particularly preferably 3 mass % or more of a structural unit derived from the above functional group-containing monomer. From another aspect, the above polymer may preferably contain 40 mass % or less and particularly preferably 20 mass % or less of the above structural unit.

From the viewpoint of developing a desired adhesive strength, the (meth)acrylic ester polymer may preferably contain a (meth)acrylic alkyl ester as a monomer unit constituting the polymer. In particular, it may be preferred to use an acrylic alkyl ester having a carbon number of 1 to 18. Specific examples thereof include methyl (meth)acrylate, n-butyl (meth)acrylate, and 2-ethylhexyl (meth)acrylate, among which n-butyl (meth)acrylate may preferably be used. These may each be used alone or two or more types may also be used in combination.

The (meth)acrylic ester polymer may preferably contain 50 mass % or more and particularly preferably 80 mass % or more of the structural unit derived from the above (meth)acrylic alkyl ester. From another aspect, the above polymer may preferably contain 99 mass % or less and particularly preferably 97 mass % or less of the above structural unit.

The (meth)acrylic ester polymer may be a polymer obtained by copolymerizing the above-described functional group-containing monomer and (meth)acrylic alkyl ester together with other monomers. The polymerization form of the polymer may be a random copolymer or may also be a block copolymer. One type of the polymer may be used alone or two or more types may also be used in combination.

The weight-average molecular weight of the (meth)acrylic ester polymer may be preferably 300,000 or more and particularly preferably 1,000,000 or more. From another aspect, the above weight-average molecular weight may be preferably 2,500,000 or less and particularly preferably 2,000,000 or less. When the weight-average molecular weight of the (meth)acrylic ester polymer is within the above range, the storage elastic modulus to be described later may readily be satisfied, and the previously described indentation depth may readily be achieved.

It suffices that the above crosslinker is one that reacts with the reactive functional group of the (meth)acrylic ester polymer. For example, it may be preferred to use an epoxy-based crosslinker, an isocyanate-based crosslinker, or the like. One type of the closslinker may be used alone or two or more types may also be used in combination.

The content of the crosslinker in the pressure sensitive adhesive composition may be preferably 0.01 mass parts or more and particularly preferably 0.1 mass parts or more with respect to 100 mass parts of the (meth)acrylic ester polymer. From another aspect, the content may be preferably 10 mass parts or less and particularly preferably 5 mass parts or less.

If desired, various additives usually used in acrylic-based pressure sensitive adhesives can be added to the pressure sensitive adhesive composition. Examples of such additives include an active energy ray-curable component, a photopolymerization initiator, a silane coupling agent, an antistatic, a tackifier, an antioxidant, a light stabilizer, a softening agent, a filler, a refractive index adjuster, and a light diffusing agent.

The pressure sensitive adhesive composition can be produced through producing a (meth)acrylic ester polymer and mixing the obtained (meth)acrylic ester polymer and a crosslinker and, if desired, an additive. The (meth)acrylic ester polymer can be produced by polymerizing a mixture of monomers constituting the polymer using a commonly-used radical polymerization method. Polymerization of the (meth)acrylic ester polymer may preferably be carried out by a solution polymerization method using a polymerization initiator if desired. The pressure sensitive adhesive composition may be prepared as a coating solution of the pressure sensitive adhesive composition through adding a diluting solvent to the pressure sensitive adhesive component and mixing them sufficiently.

The lower limit of the gel fraction of the pressure sensitive adhesive constituting the pressure sensitive adhesive layer may be preferably 40% or more, particularly preferably 60% or more, and further preferably 70% or more. On the other hand, the upper limit of the gel fraction of the above pressure sensitive adhesive may be preferably 99% or less, particularly preferably 90% or less, and further preferably 85% or less. When the gel fraction of the pressure sensitive adhesive is within the above range, the previously described indentation depth may readily be achieved.

The above-described gel fraction of the pressure sensitive adhesive can be measured by a general scheme. For example, when the pressure sensitive adhesive is immersed in ethyl acetate at room temperature (23° C.) for 72 hours, the gel fraction can be calculated based on the mass of the pressure sensitive adhesive before and after the immersion. That is, when the mass of the pressure sensitive adhesive before the immersion is M1 and the mass of the pressure sensitive adhesive after being immersed and then sufficiently dried is M2, the gel fraction can be obtained from the formula (M2/M1)×100.

The storage elastic modulus at 23° C. of the pressure sensitive adhesive layer may be preferably 0.02 MPa or more, particularly preferably 0.06 MPa or more, and further preferably 0.09 MPa or more. From another aspect, the storage elastic modulus may be preferably 0.50 MPa or less, particularly preferably 0.20 MPa or less, and further preferably 0.14 MPa or less. When the storage elastic modulus at 23° C. of the pressure sensitive adhesive layer is within the above range, the previously described indentation depth may readily be achieved.

The above storage elastic modulus may be measured by a torsional shear method in accordance with JIS K7244-6:1999 using a viscoelasticity measurement device (e.g., product name “DYNAMIC ANALYZER” available from REOMETRIC) under the condition of measurement frequency: 1 Hz and measurement temperature: 23° C.

The lower limit of the thickness of the pressure sensitive adhesive layer may be preferably 20 μm or more, particularly preferably 40 μm or more, and further preferably 70 μm or more. When the lower limit of the thickness of the pressure sensitive adhesive layer is as described above, the previously described indentation depth may readily be achieved, and the desired adhesive strength may readily be exhibited. On the other hand, the upper limit of the thickness of the pressure sensitive adhesive layer may be preferably 300 μm or less, particularly preferably 200 μm or less, and further preferably 150 μm or less. When the upper limit of the thickness of the pressure sensitive adhesive layer is as described above, a touch panel including the writing feel improving sheet may readily be made thin.

The lower limit of the ratio of the thickness of the pressure sensitive adhesive layer to the sum of the thicknesses of the base material and the writing feel improving layer may be preferably 0.2 times or more, particularly preferably 0.5 times or more, and further preferably 1 time or more. When the lower limit of the above ratio is as described above, the previously described indentation depth may readily be achieved. On the other hand, the upper limit of the above ratio may be preferably 5.0 times or less, more preferably 3.5 times or less, and further preferably 2.0 times or less. When the upper limit of the above ratio is as described above, even when the pressure sensitive adhesive layer is thick (e.g., when the thickness of the pressure sensitive adhesive layer is 150 μm or more), it may have sufficient pencil hardness.

### (4) Other Members

The writing feel improving sheet according to the present embodiment may further include one or more layers in addition to the previously described writing feel improving layer, base material, and pressure sensitive adhesive layer. For example, an intermediate layer having a lower elastic modulus than that of the writing feel improving layer may be provided between the writing feel improving layer and the base material. Additionally or alternatively, a release sheet may be laminated on the surface of the pressure sensitive adhesive layer opposite to the base material.

The above intermediate layer can be provided from the viewpoint of readily achieving the previously described indentation depth. The same material as that of the writing feel improving layer can be used as the material of the intermediate layer, and it is particularly preferred to form the intermediate layer using the previously described coating composition.

When the intermediate layer is provided, its thickness may be preferably 5 μm or more, particularly preferably 10 μm or more, and further preferably 20 μm or more from the viewpoint of readily achieving the previously described indentation depth. From the same viewpoint, the thickness of the intermediate layer may be preferably 50 μm or less, particularly preferably 40 μm or less, and further preferably 35 μm or less.

When the writing feel improving sheet includes the above intermediate layer, the writing feel improving layer is liable to crack during the use of a touch pen. Such a tendency becomes strong especially when the writing feel improving layer is a hard coat layer. From such a viewpoint, the writing feel improving sheet according to the present embodiment may preferably include no intermediate layer, that is, the writing feel improving layer may preferably be laminated directly on one surface of the base material. It is to be noted that, in the present specification, even when the writing feel improving layer is laminated directly on one surface of the base material, the previously described easy-adhesion layer and/or surface treatment layer may be present on the writing feel improving sheet side of the base material, as previously described.

Examples of the release sheet for use include a polyethylene film, a polypropylene film, a polybutene film, a polybutadiene film, a polymethylpentene film, a polyvinyl chloride film, a vinyl chloride copolymer film, a polyethylene terephthalate film, a polyethylene naphthalate film, a polybutylene terephthalate film, a polyurethane film, an ethylene-vinyl acetate film, an ionomer resin film, an ethylene-(meth)acrylic acid copolymer film, an ethylene-(meth)acrylic ester copolymer film, a polystyrene film, a polycarbonate film, a polyimide film, a fluorine resin film, and a liquid crystal polymer film. Crosslinked films thereof may also be used. A laminate film obtained by laminating a plurality of such films may also be used.

It may be preferred to perform release treatment for the release surface (surface to be in contact with the pressure sensitive adhesive layer) of the release sheet. Examples of a release agent to be used for the release treatment include alkyd-based, silicone-based, fluorine-based, unsaturated polyester-based, polyolefin-based, and wax-based release agents.

The thickness of the release sheet is not particularly limited, but may ordinarily be about 20 to 150 μm.

### 3. Production Method for Writing Feel Improving Sheet

The production method for the writing feel improving sheet according to the present embodiment is not particularly limited, provided that the writing feel improving sheet can achieve the previously described indentation depth. For example, the writing feel improving sheet in which the writing feel improving layer, the base material, and the pressure sensitive adhesive layer are laminated in this order can be obtained through producing a laminate composed of the writing feel improving layer and the base material and a laminate composed of the pressure sensitive adhesive layer and the release sheet and then attaching these laminates to each other so that the base material and the pressure sensitive adhesive layer come into contact with each other.

The above-described laminate composed of the writing feel improving layer and the base material can be obtained, for example, through coating one surface of the base material with a coating liquid that contains the previously described coating composition and, if desired, a solvent and curing the obtained coating film to form the writing feel improving layer.

The above solvent can be used for improvement of coating properties, adjustment of viscosity, adjustment of solid content concentration, and the like. Such a solvent can be used without particular limitation, provided that it dissolves curable components and the like and disperses fine particles and the like.

Specific examples of the solvent include alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, and γ-butyrolactone; ethers such as ethylene glycol monomethyl ether (methyl cellosolve), ethylene glycol monoethyl ether (ethyl cellosolve), diethylene glycol monobutyl ether (butyl cellosolve), and propylene glycol monomethyl ether; aromatic hydrocarbons such as benzene, toluene, and xylene; and amides such as dimethylformamide, dimethylacetamide, and N-methylpyrrolidone.

The coating with the coating liquid of the coating composition may be performed using an ordinary method, such as a bar coating method, a knife coating method, a roll coating method, a blade coating method, a die coating method, or a gravure coating method. After the coating with the coating liquid of the coating composition, it may be preferred to dry the coating film at 40° C. to 120° C. for about 30 seconds to 5 minutes.

When the coating composition has active energy ray curability, the coating composition may be cured by irradiating the coating film of the coating composition with active energy rays such as ultraviolet rays and electron rays. Irradiation with ultraviolet rays can be performed using a high-pressure mercury lamp, a fusion H lamp, a xenon lamp, or the like, and the irradiance level of ultraviolet rays may be preferably about 50 to 1,000 mW/cm² as the illuminance and about 50 to 1,000 mJ/cm² as the light amount and particularly preferably about 100 to 500 mW/cm² as the illuminance and about 100 to 500 mJ/cm² as the light amount. On the other hand, irradiation with electron rays can be performed using an electron ray accelerator or the like, and the irradiance level of electron rays may be preferably about 10 to 1,000 krad.

The above-described laminate composed of the pressure sensitive adhesive layer and the release sheet can be obtained, for example, through coating the release surface of the release sheet with a coating liquid that contains the previously described pressure sensitive adhesive composition and, if desired, a solvent and subjecting the obtained coating film to a drying process or the like to form the pressure sensitive adhesive layer. The solvent is not particularly limited and various ones can be used. For example, the previously described solvent for preparing the coating liquid of the coating composition can be used. Also as the method of coating with the coating liquid, for example, the same method as that for coating with the coating liquid of the coating composition can be used. The drying process or the like for the coating film of the pressure sensitive adhesive composition can be performed, for example, by heating the coating film at a temperature of 80° C. or higher and 180° C. or lower for 10 seconds or longer and 5 minutes or shorter. Furthermore, after such heat treatment, an aging period of about 1 to 2 weeks at an ordinary temperature (e.g., 23° C., 50% RH) may be provided.

### 4. Use of Writing Feel Improving Sheet

The writing feel improving sheet according to the present embodiment can be used as a sheet that constitutes the outermost layer of a touch panel (image display device with position detection function) on which a touch pen is used. Specifically, the writing feel improving sheet may preferably be used by being laminated on the cover material of a display body module such as a liquid crystal (LCD) module, a light emitting diode (LED) module, or an organic electroluminescence (organic EL) module or the cover material of a touch panel having a touch sensor or the like. Lamination of the writing feel improving sheet on the cover material may preferably be performed by attaching the writing feel improving sheet to the cover material via the previously described pressure sensitive adhesive layer.

The touch pen used for the writing feel improving sheet according to the present embodiment is not particularly limited, and a conventionally known one can be used. As the touch pen, for example, a touch pen having a polyacetal pen tip, a touch pen having a hard felt pen tip, a touch pen having an elastomer pen tip, or the like can be used. The shape of the pen tip of a touch pen is not particularly limited, and can be appropriately selected from a disk shape, a circular shape, a polygonal shape, and the like, but from the viewpoint that the feeling of vibration when writing with a ballpoint pen can be obtained, a circular shape may be preferred. When the shape of the pen tip of a touch pen is a circular shape, the diameter of the pen tip may be preferably 0.1 mm or more, particularly preferably 0.2 mm or more, and further preferably 0.3 mm or more. From another aspect, the above diameter may be preferably 5 mm or less, particularly preferably 2 mm or less, and further preferably 1 mm or less.

The writing feel improving sheet according to the present embodiment satisfies the previously described indentation depth and can thereby well reproduce the feeling of depression on paper when writing on the paper with a pen or pencil (in particular, a ballpoint pen). This allows the writing feel when writing on paper with a pen or pencil to be reproduced well.

5. Touch Panel with Writing Feel Improving Sheet

A touch panel with writing feel improving sheet can be obtained by laminating the writing feel improving sheet according to the present embodiment on the touch panel. Specifically, the touch panel with writing feel improving sheet includes the writing feel improving sheet having a touch pen contact surface with which a touch pen comes into contact and the touch panel. Here, a surface side of the writing feel improving sheet opposite to the touch pen contact surface is laminated on a display surface side of the touch panel. The writing feel improving sheet may be directly laminated on the display surface side of the touch panel, or laminated on the display surface side of the touch panel via other members or layers.

Types and methods of the touch panel are not particularly limited. For example, a touch panel of a capacitive type, an electro-magnetic resonance type, a resistive type, a surface acoustic wave type (an ultrasonic wave type), an infrared type, or the like can be used. Among these, a capacitive touch panel is preferable from the viewpoint that it is easier to achieve more excellent writing feel. Moreover, taking into consideration the reproducibility of characters and the like with a touch pen, a touch panel with both a capacitive type and an electro-magnetic resonance type is particularly preferable. The specific configuration and the like of the capacitive touch panel and the electro-magnetic resonance touch panel are not particularly limited, and conventionally known ones can be used.

It should be appreciated that the embodiments heretofore explained are described to facilitate understanding of the present invention and are not described to limit the present invention. It is therefore intended that the elements disclosed in the above embodiments include all design changes and equivalents to fall within the technical scope of the present invention.

### EXAMPLES

Hereinafter, the present invention will be described further specifically with reference to examples etc., but the scope of the present invention is not limited to these examples etc.

### Preparation Examples

The materials listed in Table 1 were mixed at the compositions listed in Table 2 to obtain coating compositions C1 to C4. The compounding ratios listed in Table 2 are ratios based on the solid content equivalents. The obtained coating compositions were diluted with propylene glycol monomethyl ether to obtain coating liquids of the coating compositions C1 to C4. The solid content concentrations of the obtained coating liquids are as listed in Table 2.

### Example 1

### (1) Formation of Writing Feel Improving Layer

One surface of a polyethylene terephthalate (PET) film having easy-adhesion layers on both surfaces (available from Toray Industries, Inc., product name “Lumirror U48,” thickness: 125 μm) as the base material was coated with the coating liquid of the coating composition C1 obtained in the above-described preparation examples using a Meyer bar to obtain a coating film and the coating film was then dried by heating at 70° C. for 1 minute using an oven.

Then, under a nitrogen atmosphere, the above coating film was cured by being irradiated with ultraviolet rays under the following condition using an ultraviolet irradiation apparatus (available from GS Yuasa Corporation, product name “Nitrogen purge small conveyer-type UV irradiation apparatus CSN 2-40”) to form a writing feel improving layer having a thickness of 3 μm.

### <Ultraviolet Irradiation Condition>

Light source: High-pressure mercury lamp
Lamp power: 1.4 kW
Conveyor speed: 1.2 m/min
Illuminance: 100 mW/cm²
Light amount: 240 mJ/cm²
Oxygen concentration: 1% or less

### (2) Formation of Pressure Sensitive Adhesive Layer

A (meth)acrylic ester copolymer was prepared by copolymerizing 95 mass parts of n-butyl acrylate and 5 mass parts of acrylic acid using a solution polymerization method. When the molecular weight of the (meth)acrylic ester copolymer was measured by the method described later, the weight-average molecular weight (Mw) was 1,500,000.

The coating liquid of a pressure sensitive adhesive composition was obtained through mixing and sufficiently stirring 99.8 mass parts (solid content equivalent; here and hereinafter) of the (meth)acrylic ester copolymer obtained as above and 0.2 mass parts of 1,3-bis(N,N-diglycidylaminomethyl)cyclohexane as the crosslinker and diluting them with toluene.

Subsequently, the release surface of a release sheet (available from LINTEC Corporation, product name “SP-PET381031”) in which a silicone-based release agent layer was formed on one surface of a polyethylene terephthalate film having a thickness of 38 μm was coated with the coating liquid of the pressure sensitive adhesive composition obtained as above using an applicator to form a coating film. The coating film was dried by heating at 100° C. for 3 minutes using an oven and aged under a condition of 23° C. and 50% RH for 7 days, and a pressure sensitive adhesive layer having a thickness of 50 μm, a gel fraction of 80%, and a storage elastic modulus of 0.12 MPa at 23° C. was formed on the release sheet.

Here, the above-described weight-average molecular weight (Mw) refers to a weight-average molecular weight that is measured as a polystyrene equivalent value under the following condition using gel permeation chromatography (GPC) (GPC measurement).

### <Measurement Condition>

GPC measurement apparatus: HLC-8320 available from Tosoh Corporation
GPC columns (passing through in the following order): available from Tosoh Corporation
   TSK gel super H-H
   TSK gel super HM-H
   TSK gel super H2000
Solvent for measurement: tetrahydrofuran
Measurement temperature: 40° C.

### (3) Formation of Writing Feel Improving Sheet

The surface on the base material side of the laminate of the base material and writing feel improving layer obtained in the above-described step (1) and the surface on the pressure sensitive adhesive layer side of the laminate of the release sheet and pressure sensitive adhesive layer obtained in the above-described step (2) were attached to each other thereby to obtain a writing feel improving sheet in which the writing feel improving layer, the base material, the pressure sensitive adhesive layer, and the release sheet were laminated in this order.

### Examples 2 to 15 and Comparative Example 1

Writing feel improving sheets were produced in the same manner as in Example 1 except that the type of the coating composition used, the thickness of the writing feel improving layer, the type and thickness of the base material used, and the thickness of the pressure sensitive adhesive layer were as listed in Table 3.

### Example 16

One surface of a polyethylene terephthalate (PET) film having easy-adhesion layers on both surfaces (available from Toray Industries, Inc., product name “Lumirror U48,” thickness: 125 μm) as the base material was coated with the coating liquid of the coating composition C4 obtained in the above-described preparation examples using a Meyer bar to obtain a coating film and the coating film was then dried by heating at 70° C. for 1 minute using an oven. Subsequently, the above coating film was irradiated with ultraviolet rays under the previously described ultraviolet irradiation conditions to cure the above coating film. An intermediate layer having a thickness of 30 μm was thus formed.

Further, the surface on the intermediate layer side of the laminate which was obtained as above and in which the intermediate layer was formed on one surface of the base material was coated with the coating liquid of the coating composition C1 obtained in the above-described preparation examples using a Meyer bar to obtain a coating film and the coating film was then dried by heating at 70° C. for 1 minute using an oven. Subsequently, the above coating film was irradiated with ultraviolet rays under the previously described ultraviolet irradiation conditions to cure the above coating film. A writing feel improving layer having a thickness of 3 μm was thus formed.

To the surface on the base material side of the laminate which was obtained as above and in which the writing feel improving layer, the intermediate layer, and the base material were laminated in this order, the surface on the pressure sensitive adhesive layer side of the laminate of the release sheet and pressure sensitive adhesive layer obtained in the same manner as in the step (2) of the previously described Example 1 was attached thereby to obtain a writing feel improving sheet in which the writing feel improving layer, the intermediate layer, the base material, the pressure sensitive adhesive layer, and the release sheet were laminated in this order.

### <Testing Example 1> (Measurement of Optical Properties)

The release sheet was removed from the writing feel improving sheet produced in each of Examples and Comparative Example, the exposed surface (pressure sensitive adhesive surface) of the exposed pressure sensitive adhesive layer was attached to a glass plate (thickness: 1.2 mm), and this was used as a sample for measurement.

Then, after performing the background measurement on the glass plate alone, a haze meter (available from NIPPON DENSHOKU INDUSTRIES CO., LTD., product name “NDH-5000”) was used for the above sample for measurement to measure the haze value (%) of the writing feel improving sheet in accordance with JIS K7136:2000 and measure the total luminous transmittance (%) of the writing feel improving sheet in accordance with JIS Z8741:1997. These results are listed in Table 3.

For the surface on the writing feel improving layer side (touch pen contact surface) of the sample for measurement obtained in the same manner as above, the glossiness at a measurement angle of 60° was measured in accordance with JIS Z8741:1997 using a glossiness meter (available from NIPPON DENSHOKU INDUSTRIES CO., LTD., product name “VG7000”). The results are listed in Table 3.

### <Testing Example 2> (Measurement of Indentation Depth)

The release sheet was removed from the writing feel improving sheet produced in each of Examples and Comparative Example, the exposed surface (pressure sensitive adhesive surface) of the exposed pressure sensitive adhesive layer was attached to a glass plate (thickness: 1.2 mm), and this was used as a sample for measurement.

After the above sample for measurement was set on a micro surface hardness tester (available from Shimadzu Corporation, product name “Shimadzu Dynamic Ultra Micro Hardness Tester W201S”), the surface on the writing feel improving layer side (touch pen contact surface) of the above sample for measurement was indented with the tip of a triangular pyramid-shaped indenter (Berkovich type, tip curvature radius: 100 nm, inter-ridge angle: 115°) at a load speed of 1 mN/s, and the indentation depth (μm) when the test load reached 1961 mN was measured. The results are listed in Table 3.

As a reference, the indentation depth of paper was also measured. Specifically, in a state in which 20 sheets of commercially available papers (available from KOKUYO Co., Ltd., product name “Campus Loose Leaf SHIKKARIKAKERU,” product model number “NO-S836BT,” size: B5, ruled width: B-ruled) were stacked, these sheets of papers were set on a support table of the above micro surface hardness tester, and the indentation depth (μm) was then measured for the outermost surface of the stacked sheets of papers under the same condition as above. As a result, a measured value of 17.8 μm was obtained.

### <Testing Example 3> (Friction Measurement)

The release sheet was removed from the writing feel improving sheet produced in each of Examples and Comparative Example, the exposed surface (pressure sensitive adhesive surface) of the exposed pressure sensitive adhesive layer was attached to a glass plate (thickness: 1.2 mm), and this was used as a sample for measurement.

The above sample for measurement was set on a dedicated carriage for measurement of a static and dynamic friction tester (available from Trinity-Lab Inc., product name “Tribomaster TL201 Ts”) so that the surface on the writing feel improving layer side (touch pen contact surface) was on the upper side. The above dedicated carriage for measurement is configured to reciprocally move in a predetermined direction while keeping the setting surface of the above sample for measurement horizontal as the above static and dynamic friction tester is used.

Subsequently, a touch pen was fixed to the above static and dynamic friction tester so that the pen tip came into contact with the touch pen contact surface. At that time, the touch pen was inclined and fixed so that the angle formed between the touch pen and the touch pen contact surface was 45°. In addition, the tilting direction at that time was inclined toward the traveling direction side of the dedicated carriage for measurement and parallel to the traveling direction. The touch pen used was a touch pen having a polyacetal (POM) pen tip (available from Wacom Co., Ltd., product name “ACK-20001,” pen tip diameter: 0.5 mm).

Subsequently, in a state in which a load was applied to the touch pen under a pressurization condition of a load of 200 g, the above-described dedicated carriage for measurement was moved at a speed of 1.6 mm/s thereby to slide the touch pen on the touch pen contact surface (sliding distance: 100 mm), and on the basis of the friction force measured at that time, the static and dynamic friction coefficients and the standard deviation (mN) of the friction force were calculated. The standard deviation of the friction force was calculated for the friction force measured between a point at which the sliding distance was 10 mm and a point at which the sliding distance was 20 mm. The results are listed in Table 3.

As a reference, the static and dynamic friction coefficients when writing on paper with a ballpoint pen were also measured. Specifically, in a state in which 20 sheets of commercially available papers (available from KOKUYO Co., Ltd., product name “Campus Loose Leaf SHIKKARIKAKERU,” product model number “NO-S836BT,” size: B5, ruled width: B-ruled) were stacked, these sheets of papers were set on the dedicated carriage for measurement of the above static and dynamic friction tester, and a ballpoint pen (available from BIC, product name “Orange EG 1.0,” oil-based ballpoint pen, pen tip diameter: 1.0 mm) was fixed to the above static and dynamic friction tester so that the pen tip came into contact with the outermost surface of the stacked sheets of papers. Then, the ballpoint pen was slid on the surface of the paper under the same condition as above, and on the basis of the friction force measured at that time, the static and dynamic friction coefficients and the standard deviation (mN) of the friction force were calculated. As a result, the static friction coefficient was 0.28, the dynamic friction coefficient was 0.27, and the standard deviation of the friction force was 30 mN.

### <Testing Example 4> (Evaluation of Writing Feel)

The release sheet was removed from the writing feel improving sheet produced in each of Examples and Comparative Example, the exposed surface (pressure sensitive adhesive surface) of the exposed pressure sensitive adhesive layer was attached to a glass plate (thickness: 1.2 mm), and this was used as a sample for measurement.

For the surface on the writing feel improving layer side (touch pen contact surface) of the above sample for measurement, an evaluator evaluated the following writing feel items through a predetermined writing operation in a simulated manner using a touch pen having a polyacetal (POM) pen tip (available from Wacom Co., Ltd., product name “ACK-20001,” pen tip diameter: 0.5 mm). The results are listed in Table 3.

### (1) Feeling of Vibration

Whether the feeling of vibration when writing on paper with a ballpoint pen was able to be reproduced was evaluated based on the following criteria.

A: Feeling of vibration was able to be reproduced very well.

B+: Feeling of vibration was slightly strong, but was able to be reproduced well.

B−: Feeling of vibration was slightly weak, but was able to be reproduced well.

C+: Feeling of vibration was too strong and was not able to be reproduced well.

C−: Feeling of vibration was too weak and was not able to be reproduced well.

### (2) Feeling of Depression

Whether the feeling of depression when writing on paper with a ballpoint pen was able to be reproduced was evaluated based on the following criteria.

A: Feeling of depression was able to be reproduced very well.

B+: Feeling of depression was slightly strong, but was able to be reproduced well.

B−: Feeling of depression was slightly weak, but was able to be reproduced well.

C+: Feeling of depression was strong, but was able to be reproduced well.

C−: Feeling of depression was weak, but was able to be reproduced well.

D+: Feeling of depression was too strong and was not able to be reproduced well.

D−: Feeling of depression was too weak and was not able to be reproduced well.

### <Testing Example 5> (Evaluation of Antiglare Properties)

The release sheet was removed from the writing feel improving sheet produced in each of Examples and Comparative Example, the exposed surface (pressure sensitive adhesive surface) of the exposed pressure sensitive adhesive layer was attached to one surface of a black acrylic plate (available from MITSUBISHI RAYON CO., LTD., product name “Acrylite L502”), and this was used as a sample for measurement.

Then, a three-wavelength fluorescent lamp was turned on above the writing feel improving sheet, and the light was reflected by the writing feel improving sheet. The reflected light was visually observed and the antiglare properties were evaluated in accordance with the following criteria. The results are listed in Table 3.

A: The outline of the fluorescent lamp visually recognized due to reflection from the writing feel improving sheet was blurred, and the outline was not able to be determined.

B: The outline of the fluorescent lamp visually recognized due to reflection from the writing feel improving sheet was slightly blurred, and the determination of the outline was at least possible, but was very difficult.

C: The outline of the fluorescent lamp visually recognized due to reflection from the writing feel improving sheet was not blurred, and the outline was able to be easily determined.

### <Testing Example 6> (Evaluation of Scratch Resistance)

The release sheet was removed from the writing feel improving sheet produced in each of Examples and Comparative Example, the exposed surface (pressure sensitive adhesive surface) of the exposed pressure sensitive adhesive layer was attached to a glass plate (thickness: 1.2 mm), and this was used as a sample for measurement.

The surface on the writing feel improving layer side (touch pen contact surface) of the above sample for measurement was rubbed at a load of 250 g/cm² using #0000 steel wool to reciprocate it ten times within a length of 10 cm. The surface of the writing feel improving layer was visually confirmed under a three-wavelength fluorescent lamp, and the scratch resistance was evaluated in accordance with the following criteria. The results are listed in Table 3.

A: No scratches were confirmed.

B: 10 or less scratches were confirmed.

C: 11 or more scratches were confirmed.

### <Testing Example 7> (Measurement of Pencil Hardness)

The release sheet was removed from the writing feel improving sheet produced in each of Examples and Comparative Example, the exposed surface (pressure sensitive adhesive surface) of the exposed pressure sensitive adhesive layer was attached to a glass plate (thickness: 1.2 mm), and this was used as a sample for measurement.

For the surface on the writing feel improving layer side (touch pen contact surface) of the above sample for measurement, the scratch hardness was measured by the pencil method in accordance with JIS K5600-5-4:1999 under a condition of a load of 750 g and a speed of 1.0 mm/s using a pencil scratch coating hardness tester (available from Toyo Seiki Seisaku-sho, Ltd., product name “NP”). The measurement results are classified in accordance with the following criteria and listed in Table 3.

A: The pencil hardness was HB or more.

B: The pencil hardness was less than HB and 3B or more.

C: The pencil hardness was less than 3B.

Details of the abbreviations in Table 3 are as follows.
Lumirror U48: Polyethylene terephthalate (PET) film having easy-adhesion layers on both surfaces (available from Toray Industries, Inc., product name “Lumirror U48,” thickness: 50 μm, 75 μm, 100 μm, or 125 μm)
Lumirror U40: Polyethylene terephthalate (PET) film having easy-adhesion layers on both surfaces (available from Toray Industries, Inc., product name “Lumirror U40,” thickness: 23 μm)

TABLE 1

| Name of material | Symbol | Details of material |
|---|---|---|
| Curable component | a | Polyfunctional urethane acrylate |
| | | (available from ARAKAWA CHEMICAL INDUSTRIES, LTD., |
| | | product name “Beamset 575CB”) |
| | b | Bifunctional urethane acrylate |
| | | (weight-average molecular weight: 13,000) |
| Silica nanoparticles | c | Silica fine particles of average particle diameter |
| | | of 10 nm (surface-modified) |
| Fine particles | d | Material: Crosslinked polymethylmethacrylate, |
| | | Shape: spherical, Average particle diameter. 4.0 μm, |
| | | Coefficient of variation of particle diameter: 18% |
| | e | Material: Silicone, Shape: spherical, |
| | | Average partide diameter: 4.5 μm, |
| | | Coefficient of variation of particle diameter: 24% |
| Surface conditioner | f | Reactive fluorine-based oligomer |
| Photopolymerization initiator | g | α-hydroxy phenyl ketone |

TABLE 2

| | Composition of coating composition | | | | | | Solid content |
|---|---|---|---|---|---|---|---|
| Coating | Curable | Silica | Fine | Surface | Photopolymerization | Compounding ratio | concentration |
| composition | component | nanoparticles | particles | conditioner | initiator | (mass parts) | (%) |
| C1 | a | — | d | f | g | a/d/f/g = | 30 |
| | | | | | | 100/9/1/3 | |
| C2 | a | — | — | f | g | a/f/g = | 30 |
| | | | | | | 100/1/3 | |
| C3 | a | c | e | f | g | a/c/e/f/g = | 40 |
| | | | | | | 100/20/11/1/3 | |
| C4 | b | — | — | — | g | b/g = 100/5 | 50 |

TABLE 3

| | | | | | | | Pressure | | | |
|---|---|---|---|---|---|---|---|---|---|---|
| | | | | | | | sensitive | Optical properties | | |
| | Writing feel | | | | | | adhesive | | Total | |
| | improving layer | | Intermediate layer | | Base material | | layer | Haze | luminous | 60° |
| | Coating | Thickness | Coating | Thickness | | Thickness | Thickness | value | transmittance | glossiness |
| | composition | (μm) | composition | (μm) | Type | (μm) | (μm) | (%) | (%) | (%) |
| Example 1 | C1 | 3 | — | — | Lumirror U48 | 125 | 50 | 34.1 | 90.2 | 30 |
| Example 2 | C1 | 3 | — | — | Lumirror U48 | 125 | 75 | 35.2 | 90.1 | 32 |
| Example 3 | C1 | 3 | — | — | Lumirror U48 | 125 | 100 | 35.6 | 90.2 | 25 |
| Example 4 | C1 | 3 | — | — | Lumirror U48 | 125 | 150 | 35.7 | 90.1 | 30 |
| Example 5 | C1 | 3 | — | — | Lumirror U48 | 125 | 200 | 36.6 | 90.1 | 31 |
| Example 6 | C1 | 5 | — | — | Lumirror U48 | 50 | 25 | 24.2 | 90.2 | 51 |
| Example 7 | C2 | 3 | — | — | Lumirror U48 | 125 | 50 | 0.8 | 90.4 | 121 |
| Example 8 | C3 | 3 | — | — | Lumirror U48 | 100 | 75 | 33.2 | 90.2 | 32 |
| Example 9 | C3 | 3 | — | — | Lumirror U48 | 75 | 75 | 33.4 | 90.1 | 33 |
| Example 10 | C3 | 3 | — | — | Lumirror U48 | 50 | 75 | 33.7 | 90.2 | 36 |
| Example 11 | C3 | 3 | — | — | Lumirror U40 | 23 | 75 | 33.9 | 89.8 | 34 |
| Example 12 | C3 | 3 | — | — | Lumirror U48 | 100 | 150 | 33.4 | 90.4 | 31 |
| Example 13 | C3 | 3 | — | — | Lumirror U48 | 75 | 150 | 34.1 | 90.2 | 33 |
| Example 14 | C3 | 5 | — | — | Lumirror U48 | 50 | 150 | 25.3 | 90.1 | 50 |
| Example 15 | C3 | 7 | — | — | Lumirror U40 | 23 | 150 | 20.3 | 90.2 | 83 |
| Example 16 | C1 | 3 | C4 | 30 | Lumirror U48 | 125 | 50 | 36.3 | 89.3 | 41 |
| Comparative | C1 | 3 | — | — | Lumirror U48 | 125 | 25 | 34.1 | 90.6 | 36 |
| Example 1 | | | | | | | | | | |

| | | | | Standard | Evaluation of | | | | |
|---|---|---|---|---|---|---|---|---|---|
| | | | | deviation | writing feel | | Evaluation | Evaluation | |
| | Indentation | Dynamic | Static | of | Feeling | Feeling | of | of | |
| | depth | friction | friction | friction | of | of | antiglare | scratch | Pencil |
| | (μm) | coefficient | coefficient | force | vibration | depression | properties | resistance | hardness |
| Example 1 | 15.1 | 0.25 | 0.27 | 19 | A | B− | A | A | A |
| Example 2 | 15.2 | 0.28 | 0.27 | 18 | A | B− | A | A | A |
| Example 3 | 15.8 | 0.26 | 0.28 | 17 | A | B− | A | A | A |
| Example 4 | 15.9 | 0.27 | 0.29 | 18 | A | B− | A | A | A |
| Example 5 | 16.1 | 0.28 | 0.29 | 14 | A | B− | A | A | A |
| Example 6 | 11.6 | 0.20 | 0.22 | 10 | B− | C− | A | A | A |
| Example 7 | 14.6 | 0.12 | 0.13 | 7 | C− | B− | C | A | A |
| Example 8 | 16.8 | 0.26 | 0.28 | 17 | A | A | A | A | B |
| Example 9 | 17.8 | 0.28 | 0.28 | 16 | A | A | A | A | B |
| Example 10 | 19.3 | 0.27 | 0.29 | 16 | A | A | A | A | B |
| Example 11 | 19.5 | 0.29 | 0.29 | 12 | A | A | A | A | B |
| Example 12 | 17.3 | 0.28 | 0.29 | 15 | A | A | A | A | B |
| Example 13 | 18.7 | 0.28 | 0.31 | 14 | A | A | A | A | B |
| Example 14 | 17.8 | 0.26 | 0.28 | 12 | A | A | A | A | C |
| Example 15 | 16.3 | 0.22 | 0.24 | 8 | B− | B− | B | A | C |
| Example 16 | 17.3 | 0.28 | 0.33 | 14 | A | A | A | A | C |
| Comparative | 8.3 | 0.24 | 0.27 | 21 | A | D− | A | A | A |
| Example 1 | | | | | | | | | |

As apparent from Table 3, the writing feel improving sheets produced in Examples can well reproduce the feeling of depression when writing on paper with a pen or pencil, and excellent writing feel can be achieved together with good reproducibility of feeling of vibration. Moreover, for the writing feel improving sheets produced in Examples, good results are obtained in evaluation by various optical properties, antiglare properties, scratch resistance, and pencil hardness.

### INDUSTRIAL APPLICABILITY

The writing feel improving sheet of the present invention may be preferably used as the outermost layer of a touch panel on which a touch pen is used.

1. A writing feel improving sheet having a touch pen contact surface with which a touch pen comes into contact,
the touch pen contact surface having an indentation depth of 10 μm or more and 30 μm or less when a test load reaches 1961 mN upon indentation with a tip of a triangular pyramid-shaped indenter at a load speed of 1 mN/s, the triangular pyramid-shaped indenter having a tip curvature radius of 100 nm and an inter-ridge angle of 115°.

2. The writing feel improving sheet according to claim 1, having a dynamic friction coefficient of 0.11 or more and 0.62 or less when, after a pen tip of a touch pen is brought into contact with the touch pen contact surface, a load of 200 g is applied to the touch pen and the touch pen is linearly slid at a speed of 1.6 mm/s while maintaining an angle formed between the touch pen and the touch pen contact surface at 45°, the pen tip having a diameter of 0.5 mm.

3. The writing feel improving sheet according to claim 1, comprising:
a writing feel improving layer;
a base material provided on one surface side of the writing feel improving layer; and
a pressure sensitive adhesive layer provided on a surface side of the base material opposite to the writing feel improving layer,
wherein the touch pen contact surface is a surface of the writing feel improving layer opposite to the base material.

4. The writing feel improving sheet according to claim 3, wherein the writing feel improving layer is laminated directly on one surface of the base material.

5. The writing feel improving sheet according to claim 3, wherein the writing feel improving layer is a hard coat layer.

6. The writing feel improving sheet according to claim 2, comprising:
a writing feel improving layer;
a base material provided on one surface side of the writing feel improving layer; and
a pressure sensitive adhesive layer provided on a surface side of the base material opposite to the writing feel improving layer,
wherein the touch pen contact surface is a surface of the writing feel improving layer opposite to the base material.

7. The writing feel improving sheet according to claim 6, wherein the writing feel improving layer is laminated directly on one surface of the base material.

8. The writing feel improving sheet according to claim 4, wherein the writing feel improving layer is a hard coat layer.

9. The writing feel improving sheet according to claim 6, wherein the writing feel improving layer is a hard coat layer.

10. The writing feel improving sheet according to claim 7, wherein the writing feel improving layer is a hard coat layer.
